(19) United States
(12) Patent Application Publication
(10) Pub. No.: US 2020/0010197 A1
(43) Pub. Date: Jan. 9, 2020

(54) Aircraft seat dress covers with massage features

(71) Applicant: Jefto Otovic, (US)

(72) Inventor: Jefto Otovic, Woodland Hills, CA (US)

(21) Appl. No.: 16/030,159

(22) Filed: Jul. 9, 2018

(51) Int. Cl. B64D 11/06; B60N 2/58; B60N 2/90

(52) U.S. Cl. CPC B64D 11/0607; B64D 11/0647; B60N 2/976; B60N 2/58

(57) ABSTRACT

The aircraft seat dress covers with massage features are tailored specifically to provide more comfortable flight experience and accommodate unique airline seat requirements.

Massage system include encapsulated vibration motors with massage functions to provide a relaxation massage that can help alleviate sore and tight muscles, improve circulation, and relieve tension during a few hours flight.

Alternatively, the aircraft seat covers can have a heat massage therapy as well. The seat massage system is equipped with overheating protection system and auto shut off timer for safe use.

### FIELD OF THE INVENTION

The present invention relates generally to aircraft seat dress covers with massage features. Implanting a massage function into aircraft seat dress covers is very important feature to provide more comfortable flight experience.

Ergonomic design conforms to the natural shape of your back providing supportive comfort and helping to maintain proper position.

### BACKGROUND OF THE INVENTION

Comfort is an important issue in flying and is related to the fact of whether a passenger will book with the same airline again. We have been analyzing a lot of studies on the factors influencing the aircraft interior comfort experience to help us understanding how the comfort experience is built. The current research shows that passengers are aware of the seat comfort.

The most influential seat comfort factors are seat back and bottom position. The main resolution of the invention is to provide inexpensive aircraft seat dress covers with massaging features.

Uncomfortable seats and long flight hours could increase risk for deep vein thrombosis (DVT). There was a time when DVT was called economy class syndrome, the view being that those of us sitting squished up in economy class were more prone.

Implanting a massage features into aircraft seats ergonomic dress covers design accurately influencing the comfort rating during a flight.

### SUMMARY OF THE INVENTION

Long flight hours make passenger's muscles tense up in anticipation then a mid-journey massage could be the resolution. More primarily, this invention involves a unique method of adjustment of the back and bottom dress covers intended for use massage features in the aircraft passenger seats.

The imperative resolution of the present invention is to provide an inexpensive dress covers with massage features for all three types of aircraft passenger seats: Tourist, Business and First Class seats as well.

The following technical solution of massage system will be installed into aircraft seat dress covers:
Encapsulated vibration motors for massage therapy and heating pad as an optional heat therapy.

Typical dress covers are less comfortable and passengers usually complain that the lack of adjustment capability or improper positioning causes pain in their backs, especially during a flight.

It is very important that the proposed aircraft dress covers have ergonomic design which provides better connection between massage features and for the most of passenger's body contacted by the seat.

Massage car seat pads have been available in some automobile seating for quite some time but those designs are not easily adaptable for wide use on the aircraft seats.

This innovation will provide ergonomic design in accordance with specifically to accommodate unique aircraft seat requirements.

The aircraft dress covers design with massage features have to meet Federal Aviation Regulation.

The massage aircraft seat dress covers could be made of various materials such as: ultra-cozy fabric, leather, artificial leather, soft polyester that offers a comfortable and great feeling for body touch but in the same time every material has to meet flammability FAR 25.853 requirements.

The aircraft seat dress covers with massage features offer a refreshing massage treatment with few levels of vibration intensity. Through remote or APP, you can personalize your massage easily throughout the appliance, choosing any features or any position you want to massage.

The massage system has an automatic 15-minute shut off feature to prevent over-massaging and over-heat protection.

Massage feature can be controlled by user friendly hand held or integrated remote and APP controlled massage option (application on phone, tablet, touch screen, etc.).

The massage control panel will be connected with in seat power system where is applicable or will use rechargeable battery.

The aircraft seat dress covers with massage features could be integrated as part of specific seat design and preference or could be portable with universal design to fit to most of aircraft seats.

Main product features include at least 2 massage points, variable intensity and adjustable massage speed various operating modes such pulsate, tapping, rolling, wave, kneading, etc.

Alternatively, the aircraft seat dress covers could have heating features installed depends on customer preference and Federal Aviation Requirements. (FAR)

In depends on customer preference the aircraft seat dress covers can be designed and customized to have various massage points and heat pads.

Massage system can be completely independent or compatible with central computer control.

### BRIEF DESCRIPTION OF THE DRAWINGS

For a better understanding of the invention, reference is prepared to the drawings where in the essence of the proposed invention is shown with importance on some of its main elements, in which:

FIG. 1 is a general view of aircraft seats assembly with installed massage features into ergonomic seat dress covers

FIG. 2 is a detailed view of aircraft seat portable dress cover with integrated massage features

FIG. 3 is a detailed view of encapsulated waterproof vibration motors connected with control panel

### DETAILED DESCRIPTION OF THE INVENTION

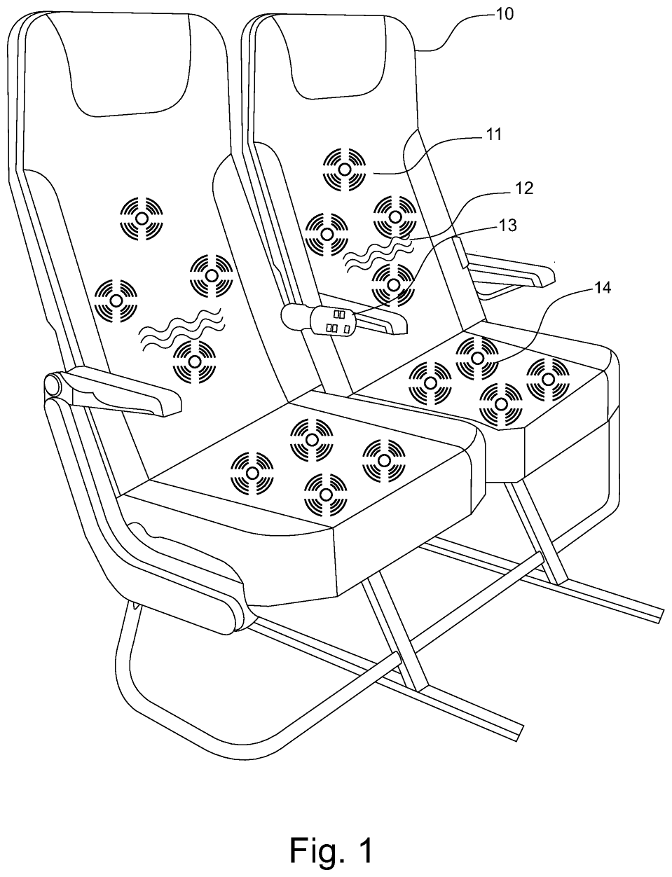

FIG. 1 is an overall view of aircraft seats assembly (10) with installed massage features into ergonomic seat dress covers

As illustrated in the figure, vibration massage motors can be installed into back (11) dress covers and bottom (14) dress covers.

The aircraft seat dress covers with massage features have to meet the following Federal Aviation Regulation (e.g. FAR 25.853).

Ergonomic back (11) and bottom (14) dress covers with padding should be made by using material that meets aviation standards. Dress covers back (11) and bottom (14) could be made by using various materials such as ultra-cozy fabric, leather, artificial leather, soft polyester that offers a comfortable and great feeling for body touch but in same time the material has to meet flammability requirements for Federal Aviation Regulation (e.g. FAR 25.853).

Padding should be made by using foam such as memory foam, dax foam and confor foam are strongly recommended because the open celled foams are breathable, non-irritating in dermal contact and help dissipate moisture and perspiration away from body are ideal for body contact cushioning application. Laminated dress covers with padding thickness approximately 0.15″ are recommended to improve the vibration performance.

Passenger control unit (13) can be hand held remote or integrated remote into seats and APP controlled massage with Bluetooth adapter. Application has to be compatible with smart phones, tablets, touch screen monitors, etc.

The location for heater pad thermostat (12) is lumber on the back cover. The heater element has to be fire resistant. Heat massage therapy installation is optional.

The massage dress cover could be designed as integrated or portable in accordance with customer preference and requirements.

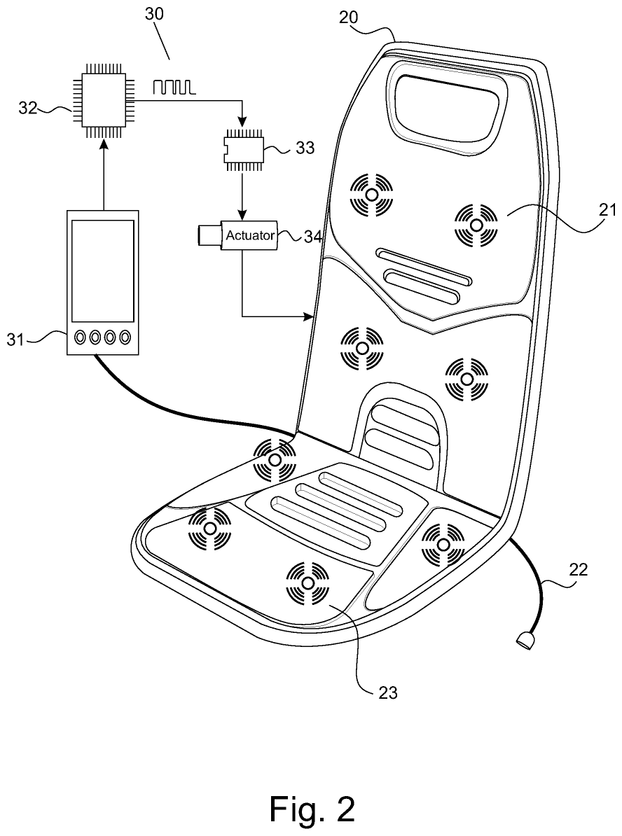

FIG. 2 contains a schematic diagram of the active portable aircraft seat back and bottom dress cover in the vibrating massage mode, according to a personification of the invention. Diagram shows portable dress cover (20) with integrated massage system with 8 massage zones.

The massage system can be constructed with 4 vibration motors in the back dress cover (21) and 4 vibration motors in the bottom dress covers (23).

The arrangement of the vibration motors could be customized in accordance with customer massage preference zone and construction of the seat back and bottom cushions.

Encapsulated waterproof vibration motors (34) are sewn directly into dress cover stitched pockets and connected with wires (30) through the dress cover padding with connector (33) and control panel (32).

The control panel (32) can be indirectly connected through USB/AC outlet and connector (22) with the seat box power (SEB) as power source.

Passenger control unit is touch screen remote (31) with wire harness connection with control panel or can be set up like wireless system with Bluetooth technology and APP remote controller.

The massage dress covers are tailored specifically to accommodate unique airline seat requirements.

The simplicity of its installing mechanism will provide easy maintenance for wide aircraft seats application.

Portable massage covers could have attach system such as strapping, velcro, zipper, snap buttons that allows this cover to fit to most aircraft seats.

This particular installing mechanism resolves a simple maintenance need that has been recognized for a long time in aviation industry.

Each vibration motor (21, 23) has sewn directly into the dress cover material. This method is widely available and generally inexpensive. The transfer of vibrations could be made more efficient because the whole pocket will vibrate.

The following dress covers with massage features will meet the airline industry standards for safe installation and easy maintenance process such as cleaning dress covers. That's why it is necessary that enclosed vibration motors need to be waterproofed.

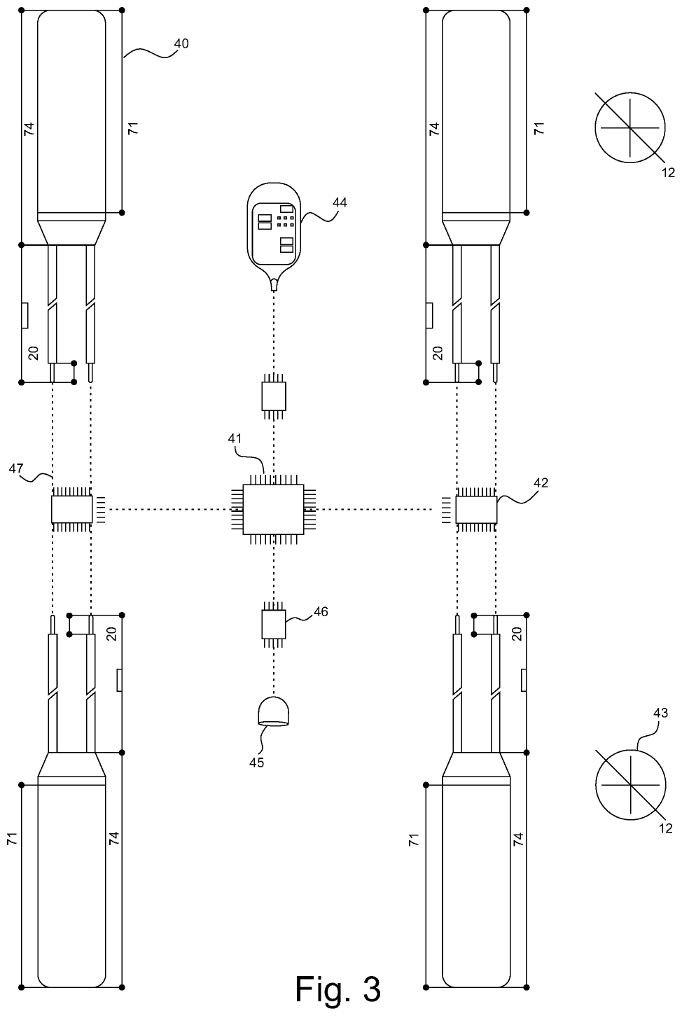

FIG. 3 contains a schematic diagram of the encapsulated waterproof vibration motors (40) connected with control panel. Diagram shows massage system connection structure and integration.

Encapsulated waterproof vibration motors (40) should be selected for massage system installation. With dress covers materials such as fabric, leather or polyester a water-proofed vibration motor is very desirable due to maintenance requirement to clean and wash dress covers.

The control panel (41) is connected with the wire harness (47) and connectors (42, 46) with the following components:
Encapsulated waterproof vibration motors (40)
USB/AC outlet and connector (45)
Passenger control unit (44) and Bluetooth adapter and connector (optional) The control panel (41) can be with wire directly connected with the seat box power (SEB) as a power source or indirectly through USB/AC outlet and connector (45). Also, rechargeable battery is option as a source of power for a short time flight.

Passenger control unit is touch screen remote (44) with wire harness connection with control panel (41) or can be set up like wireless system with Bluetooth technology and APP remote controller.

Bluetooth antenna increase the range of remote control by installing directly into control panel (41) and providing wireless connection with smart phone or tablet device via customized application program (APP).

Consuming APP remote controller option is determined by in-flight WiFi internet connectivity on board.

Vibration motor (40) has the following electrical attributes and technical characteristics:

a) Dimension—variety of motor's sizes and shape can be installed depend upon seat back and bottom construction (e.g. body diameter from 10 mm-30 mm and body length 15 mm-75 mm).

b) Water-proofed vibration motors are strongly recommended.

c) Electrical specification—rated operating voltage from 3-12 V, 115 V, 400 Hz input voltage.

d) Unit weight—lightweight vibration motors are strongly recommended (e.g. 20 g-75 g).

d) Encapsulated vibration motors are strongly recommended.

What is claimed is:

1. A comfort dress cover with massage feature for an aircraft seat comprising the relaxation support seat dress cover assembly include massaging feature for improving the blood circulation to relief alleviate sore and tight muscles and relieve tension during a few hours flight, said massaging feature means including an encapsulated waterproofed vibration motors placed parallel in a bottom and back dress cover, said support and comfort layer being the same general size and shape, means each vibration motor has sewn directly into material means the dress cover has stitched pockets fort motors, said the transfer of vibrations could be made more efficient means the whole pocket will vibrate.

2. A portable comfort dress cover with massage feature comprising encapsulated waterproofed vibration motors are arranged between comfort cover and support padding layer said the power source and the control panel can be indirectly connected through USB/AC outlet said rechargeable battery is option means power source for a short time flight.

3. Passenger control unit comprising the touch screen remote or APP (application program) remote controller means for adjusting the massage treatment and levels of vibration intensity said touch screen remote with wire connection with control panel, said wireless system with Bluetooth technology and APP (application program) remote controller.
